(19) United States
(12) Patent Application Publication
(10) Pub. No.: US 2010/0131315 A1
(43) Pub. Date: May 27, 2010

(54) RESOLVING INCIDENT REPORTS

(75) Inventors: Allen Gilbert, Austin, TX (US); Rajeev Gupta, Noida(UP) (IN); Kyle Harding, North Attleboro, MA (US); Hima P. Karanam, New Delhi (IN); Mukesh K. Mohania, New Delhi (IN); Maheswaran Surendra, Croton-on-Hudson, NY (US)

Correspondence Address: Ryan, Mason & Lewis, LLP;Suite 205, 1300 Post Road, Fairfield, CT, 06824, US

(73) Assignee: International Business Machines Corporation, Armonk, NY (US)

(21) Appl. No.: 12/277,488

(22) Filed: Nov. 25, 2008

(51) Int. Cl. G06Q 10/00; G06F 17/30; G06F 17/40

(52) U.S. Cl. 705/7

(57) ABSTRACT

Techniques for correlating a client incident with one or more enterprise events to facilitate resolution of the incident are provided. The techniques include identifying one or more configuration items relevant to the one or more enterprise events, identifying one or more configuration items relevant to the client incident, and correlating the one or more enterprise events with the client incident using the one or more configuration items to facilitate resolution of the incident.

### FIELD OF THE INVENTION

Embodiments of the invention generally relate to information technology, and, more particularly, to incident management.

### BACKGROUND OF THE INVENTION

Service requests can be reported by clients at a service desk through a web-based interface, electronic mail (e-mail), phone, etc. If the person manning the service desk cannot satisfy the request or cannot find the duplicate (incident) of it, an incident ticket is created. Incidents affect the normal running of an organization's information technology (IT) services (for example, service disruption, performance problems, etc.). Incident tickets usually involve structured information about the customer and an unstructured description of the problem, among other things.

Incident management processes can have various steps such as, for example, incident classification, incident routing, root-cause analysis, resolution and recovery. In existing approaches, these processes are largely manual, leading to delays and errors in incident resolution.

### SUMMARY OF THE INVENTION

Principles and embodiments of the invention provide techniques for resolving incident reports by identifying system generated enterprise events related to the incident. An exemplary method (which may be computer-implemented) for correlating a client incident with one or more enterprise events to facilitate resolution of the incident, according to one aspect of the invention, can include steps of identifying one or more configuration items relevant to the one or more enterprise events, identifying one or more configuration items relevant to the client incident, and correlating the one or more enterprise events with the client incident using the one or more configuration items to facilitate resolution of the incident.

One or more embodiments of the invention or elements thereof can be implemented in the form of a computer product including a computer usable medium with computer usable program code for performing the method steps indicated. Furthermore, one or more embodiments of the invention or elements thereof can be implemented in the form of an apparatus or system including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include hardware module(s), software module(s), or a combination of hardware and software modules.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating an exemplary incident ticket, according to an embodiment of the present invention;

FIG. 2 is a diagram illustrating an exemplary incident management workflow, according to an embodiment of the present invention;

FIG. 3 is a diagram illustrating an exemplary event generation process, according to an embodiment of the present invention;

FIG. 4 is a diagram illustrating a part of a configuration management database (CMDB) data model, according to an embodiment of the present invention;

FIG. 5 is a diagram illustrating a schematic of an incident event association, according to an embodiment of the present invention;

FIG. 6 is a diagram illustrating an exemplary template for a database event, depicting its affected components, according to an embodiment of the present invention;

FIG. 7 is a flow diagram illustrating techniques for correlating a client incident with one or more enterprise events to facilitate resolution of the incident, according to an embodiment of the present invention; and

FIG. 8 is a system diagram of an exemplary computer system on which at least one embodiment of the present invention can be implemented.

### DETAILED DESCRIPTION

Principles of the present invention include associating client incidents with system generated events. One or more embodiments of the invention include associating such incidents with events occurring in enterprise systems to help in more efficient incident resolution. Additionally, the techniques described herein also include identifying system events responsible for client incidents even if configuration items (CIs) affected by an event are not explicitly mentioned.

Clients can use natural language text to describe incidents. Incidents that are reported can be caused, for example, by changes or events generated in the enterprise. As described herein, events are captured and stored in an event monitoring and/or management system. One or more embodiments of the present invention correlate the client incidents with the enterprise events to facilitate resolution of the incidents. Such a correlation can be performed, for example, using a configuration management database (CMDB), which stores various configuration items (CIs) along with their inter-relationships. Client incidents and events are correlated with the relevant CIs in the CMDB, and these CIs, along with their relationships, are used to compute the correlation between events and client incidents.

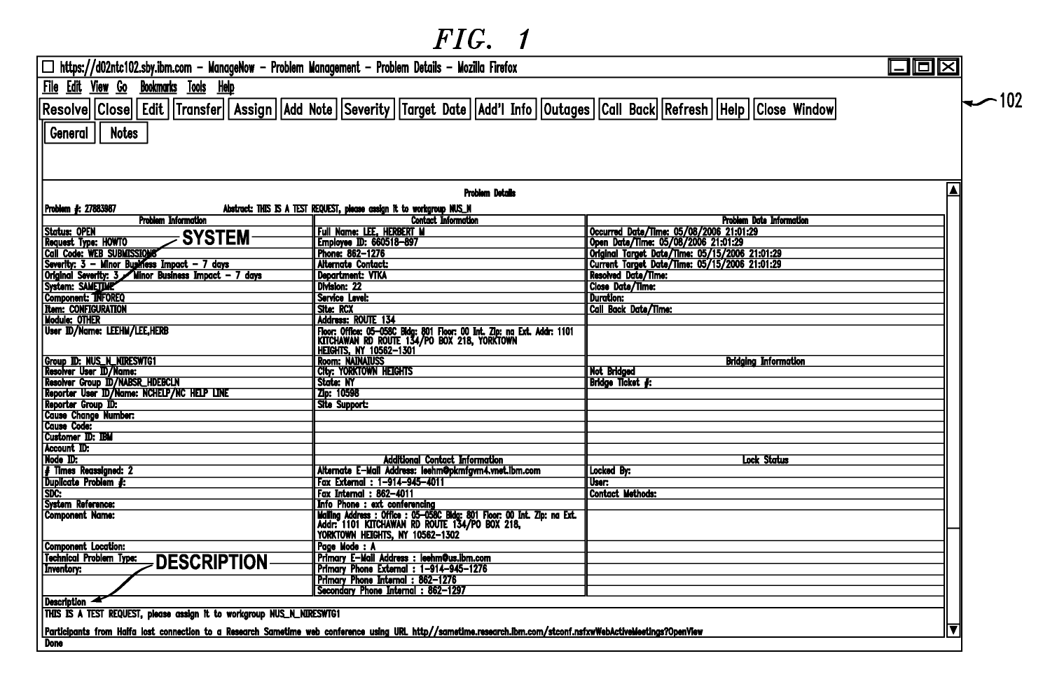

FIG. 1 is a diagram illustrating an exemplary incident ticket 102, according to an embodiment of the present invention. By way of illustration, FIG. 1 depicts an incident ticket 102 and highlights the system and description portions thereof.

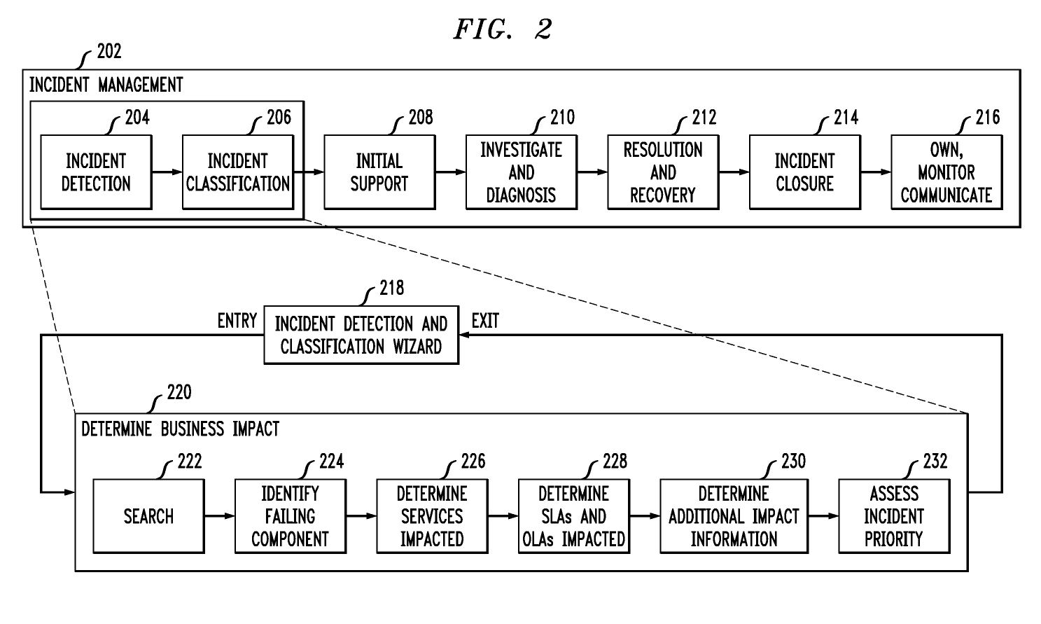

FIG. 2 is a diagram illustrating an exemplary incident management workflow, according to an embodiment of the present invention. By way of illustration, FIG. 2 depicts an incident management process 202 that includes incident detection in step 204 and incident classification 206. Those steps can further include determining an impact in process 220. Such a process can include, for example, searching in step 222, identifying a failing component in step 224, determining services impacted in step 226, determining service level agreements (SLAs) and operating level agreements (OLAs) impacted in step 228, determining additional impact information in step 230 and assessing incident priority in step 232.

The incident management process 202 depicted in FIG. 2 can also include, for example, providing initial support in step 208, investigating and diagnosing in step 210, performing a resolution and/or recovery in step 212, performing an incident closure in step 214 and owning the incident, monitoring the system for its correct functioning and communicating to the client in step 216.

The aim of incident management is to quickly resolve incidents and restore the normal functioning of IT services. Incident investigation and diagnosis (for example, as depicted in step 210 of FIG. 2) can involve identifying the root cause of the incidents. As also depicted in FIG. 2, step 218 includes using incident detection and a classification mechanism (for example, a classification wizard).

As detailed herein, a system event can be defined as any significant change in the state of an enterprise system resource, network resource, or network application. For example, one can generate an event for a problem, for the resolution of a problem, or for the successful completion of a task.

Examples of events can include normal starting and stopping of a process, abnormal process termination, server malfunction, etc. Events are generated and managed by various event management systems.

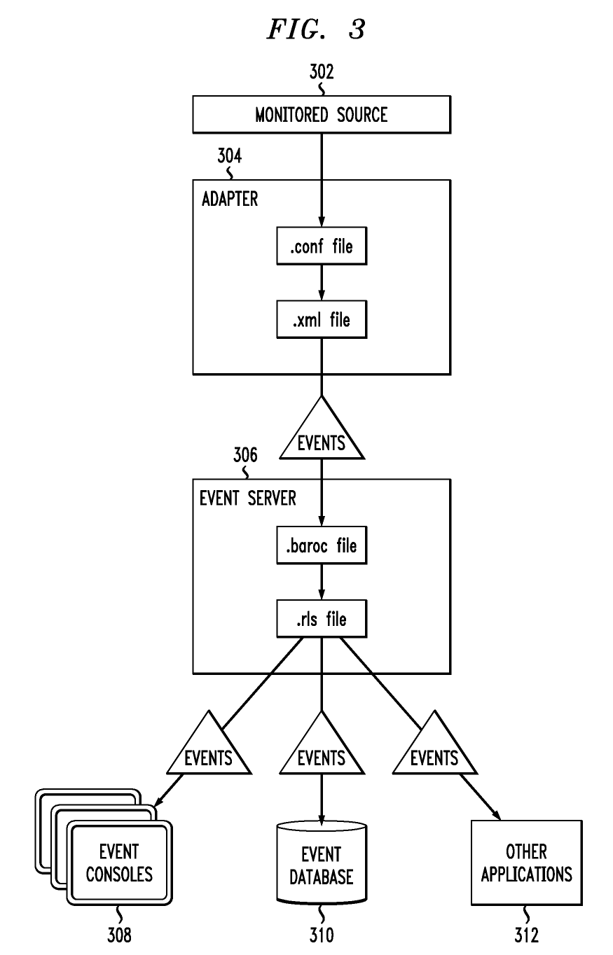

FIG. 3 is a diagram illustrating an exemplary event generation process, according to an embodiment of the present invention. By way of illustration, FIG. 3 depicts a monitored source 302, an adapter 304 (that can include, for example, a .conf file to configure the event generation and setting event attributes; and an .xml file to specify correlation engine to filter and correlate events at adaptors before forwarding them to an event server), an event server 306 (that can include, for example, a baroc file to classify events to a particular event class and an .rls file to process the events and to fire some actions, such as enriching an event or changing event criticality or deciding the operator this event has to be assigned to, etc.) that distributes events to event consoles 308, an event database 310 and other applications 312. As such, FIG. 3 depicts the parsing of log files of managed resources and the generating of events of configured classes. Also, an event server manages events via sending them to appropriate users, and correlating multiple events, etc.

Generally, events have attributes such as date, host, class-name (indicating event-type), and some class specific attributes. By way of example, event attributes may include attributes similar to the following.

Log-entry: Nov 7 08:51:42 oak su: ‘su root’ failed for don on/dev/ttyp0
Su_Failure:
source=LOGFILE;
origin=oak;
date=“Nov 7 08:51:42”;
host=oak;
sub_source=login;
from_user=don;
tty=/dev/ttyp0;
to_user=root.

As detailed herein, for a service request, one should determine if the service request is duplicate of other existing incident. If it is not a duplicate, one should create an incident for the input service request. Also, one should determine the likely cause of (client) incidents (for example, the particular system event(s)). If one can pin-point the event which is causing the incident, event resolution can resolve the incident as well. If an event is already assigned for diagnosis, then a customer may be told so. Notification can also be sent to customers not to report incidents of certain kind to avoid flooding of the service desk.

Further, one or more embodiments of the invention identify the event(s) responsible for an incident via the use of a configuration management database (CMDB). A CMDB can include a repository of information about machines, hardware, software, people, etc. in an enterprise and relationships between them. All of these objects are referred to as configuration items (CIs) having object class (for example, Computer Machine), attribute name-value pairs (Memory-size=2 gigabytes (GB)), attribute name-value pairs, sub-objects (Operating System), etc. Various configuration items can be related using explicit and/or implicit relationships. Example of relationships may include “a database installedOn a computer,” “an enterprise application runsOn a webserver,” etc. Relationships between CIs can be forward as well as backward (for example, installedOn, runsOn, etc.). Relationships between CIs can be used to find dependent hardware/software objects for a given hardware/software component (CI).

A CMDB can be accessed, for example, using Java application programming interfaces (APIs) to perform various tasks such as adding and deleting CIs, searching for CIs belonging to a particular type (for example, WebSphere Servers), browsing through Relationships, etc. A CMDB can also have structured query language- (SQL)-like language to search (for example, to get names of all computer-systems having more than two central processing units (CPUs)). Additionally, discovery mechanisms can be used to populate a CMDB automatically.

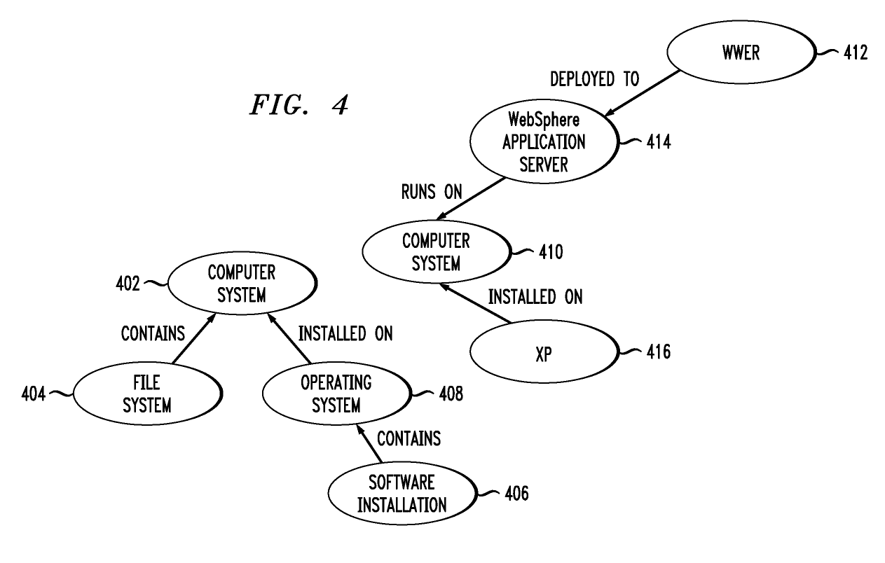

FIG. 4 is a diagram illustrating a part of a configuration management database (CMDB) data model, according to an embodiment of the present invention. By way of illustration, FIG. 4 depicts a computer system 402, a file system 404, a software installation component 406 and an operating system 408. FIG. 4 also depicts a computer system 410, any application 412 (for example, WWER), a WebSphere application server 414 and an operating system XP 416. FIG. 4 depicts example contents of a CMDB in graphical format. It shows CIs as nodes and relationship between them as edges. This graph can be interpreted, for example, as a computer system that is related to its file system and software's installed thereon: a Websphere application server installed on a computer which is running a Java application. Such a computer can run an XP operating system, etc.

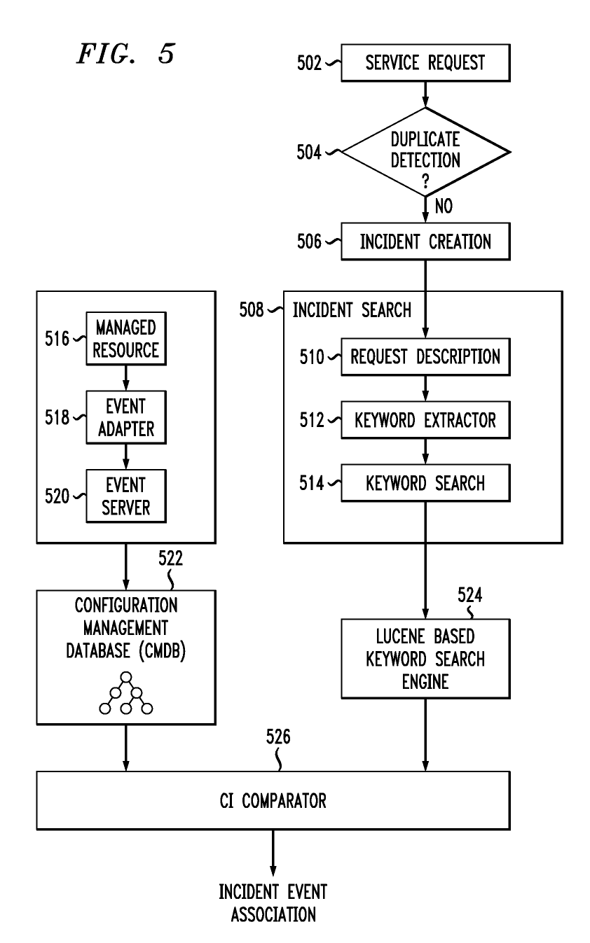

FIG. 5 is a diagram illustrating a schematic of an incident event association, according to an embodiment of the present invention. By way of illustration, FIG. 5 depicts a service request in step 502, a duplicate detection in step 504, an incident creation in step 506 and an incident search in step 508. And incident search can include requesting description in step 510, extracting keywords in 512 and searching for keywords in step 514. FIG. 5 also depicts a managed resource 516, an event adapter 518, an event server 520, a CMDB 522, an optional Lucene based keyword search engine 524 and a CI comparator 526.

As part of incident-CI association, one or more embodiments of the invention use incident description to extract keywords. These keywords are searched over a configuration management database (CMDB) to obtain associated CIs. A Lucene based search engine and other search techniques can be employed to make this search efficient and more accurate. All (unresolved) events can be obtained from the event server, and these CIs associated with the incident along with their relevancy scores can be denoted as ICI₁, ICI₂, . . . , ICIₙ and S₁, S₂, Sₙ, respectively. One or more CIs are associated with every event using an event-search. A CI associated with the event is usually explicitly mentioned in the events or can be searched using the same technique as used for client reported incidents. For obtaining an event CI, event attributes and/or description can be searched over a CMDB and a resultant CI can be obtained.

A CI comparator can take input such as, for example, results of an incident-search (for example, a list of CIs with their relevancy scores (denoted as ICI₁, ICI₂, . . . , ICIₙ and S₁, S₂, . . . , Sₙ, respectively)) as well as results of an event-search (for example, a CI (such as, for example, ECI)). Also, a CI comparator can include output such as, for example, a list of events with their relevance score.

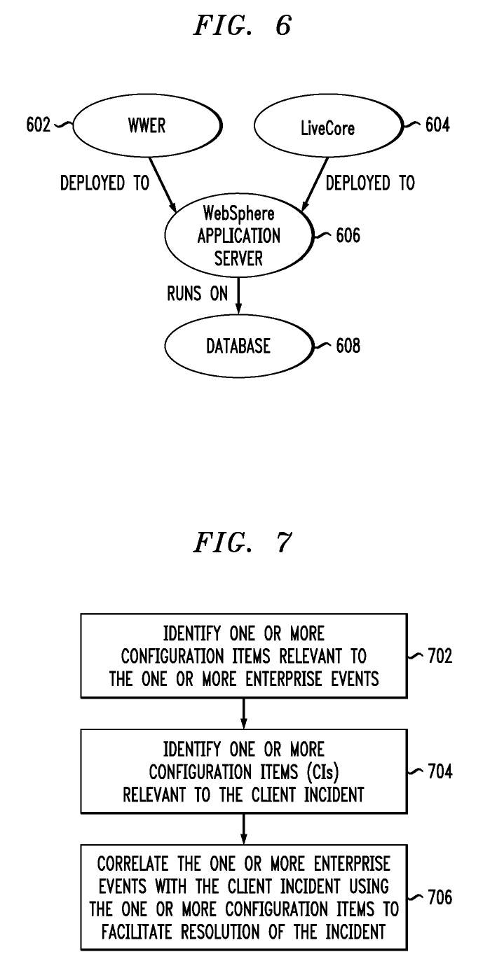

A list of events correlated with the client incident can be obtained by comparing an incident search result (ICIs) with the event search result (ECI or explicitly mentioned CI) using various intuitions including:
If ECI, for an event, is the same as any of ICIᵢ (for 1≦i≦n) for the incident then one can say that the event is correlated with the incident.
If ECI, for an event, is a dependent CI of any of ICIᵢ for 1≦i≦n, that event is correlated with the incident. This dependence can be defined using CMDB relationships. An ECI is dependent on ICI if ECI and ICI are related using one or more relationships, directly or indirectly.
For efficient implementation, dependence between an ECI and ICIs can be defined using template (such as shown in FIG. 6). According to such a template, if ECI is a Database then its dependent ICIs include all CIs of type WebSphere Application Server related to the ECI using runsOn relationship and WWER and LiveCore applications deployedTo the related WebSphere Application Server ICIs.
For increasing precision of the resultant events, one can only present events that have occurred before the incident or in recent past. Also, by way of example, an event is a more likely cause if the event is still unresolved, if the time difference between incident and event is low and/or the score of ICIk, which is dependent on the ECI, is high.

Additionally, in one or more embodiments of the invention, wherein for each event Ek, one can get the relationship-graph (template) affected by the event. This graph may include all CIs which have a backward relationship with ECIk, directly or indirectly. To limit CIs affected by the event, one or more embodiments of the invention associate a template with each event class which defines CIs affected by any event of that class. A template is in the form of a tree rooted at the ECI class, with nodes being classes of other CIs dependent on ECI and edges being CMDB relationships. One can assign non-zero scores to all the events whose relationship-graph includes any ICI. As such, the score can be inversely proportional to the time difference between event arrival and incident arrival if the time different is positive, and is proportional to a maximum score of ICIₖ (max Sₖ) appearing in its relationship graph.

FIG. 6 is a diagram illustrating an exemplary template for a database event, depicting its affected components, according to an embodiment of the present invention. By way of illustration, FIG. 6 depicts any application 602 (for example, WWER), a LiveCore component 604, a WebSphere application server 606 and a database 608. One or more embodiments of the invention include a template, which can define a set of incident-CI classes for each event class (for example, for a database event {database, WebSphere Application Server, WWER, LiveCore}) and can be the set of possible incident CI classes, as exemplified by FIG. 6.

FIG. 7 is a flow diagram illustrating techniques for correlating a client incident with one or more enterprise events to facilitate resolution of the incident, according to an embodiment of the present invention. Step 702 includes identifying one or more configuration items relevant to the one or more enterprise events (for example, enterprise events responsible for the client incident). Step 704 includes identifying one or more configuration items (CIs) relevant to the client incident. Step 706 includes correlating the one or more enterprise events with the client incident using the one or more configuration items to facilitate resolution of the incident.

Correlating the enterprise event(s) with the client incident can include, for example, using a database to identify configuration items responsible for the enterprise event(s) and the incident. Additionally, identifying the enterprise events and configuration items (CIs) can include, for example, using a database (such as, for example, a CMDB) to identify the configuration items (CIs) responsible for enterprise events and user incidents. A CMDB can, by way of example, store CIs and their inter-relationships.

The techniques depicted in FIG. 7 can also include determining whether the client incident is a repeat of an already existing incident as well as, for example, determining, for each event, a relationship-graph affected by the event. Also, one can associate a template with each event class to limit a number of CIs affected by the events of the designated event class. The template can include, for example, a tree rooted at a configuration item class (CI class) (for example, of the CI responsible for the one or more events called event CI class) with nodes being one or more classes of other configuration items dependent on the event CI class and edges being one or more CMDB relationships.

A variety of techniques, utilizing dedicated hardware, general purpose processors, software, or a combination of the foregoing may be employed to implement the present invention. At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

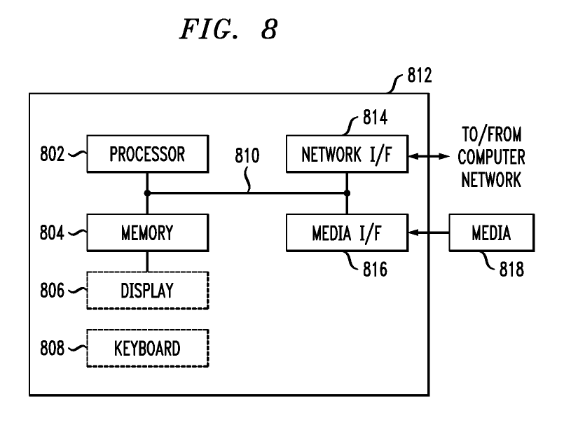

At present, it is believed that the preferred implementation will make substantial use of software running on a general-purpose computer or workstation. With reference to FIG. 8, such an implementation might employ, for example, a processor 802, a memory 804, and an input and/or output interface formed, for example, by a display 806 and a keyboard 808. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input and/or output interface” as used herein, is intended to include, for example, one or more mechanisms for inputting data to the processing unit (for example, mouse), and one or more mechanisms for providing results associated with the processing unit (for example, printer). The processor 802, memory 804, and input and/or output interface such as display 806 and keyboard 808 can be interconnected, for example, via bus 810 as part of a data processing unit 812. Suitable interconnections, for example via bus 810, can also be provided to a network interface 814, such as a network card, which can be provided to interface with a computer network, and to a media interface 816, such as a diskette or CD-ROM drive, which can be provided to interface with media 818.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 818) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory (for example, memory 804), magnetic tape, a removable computer diskette (for example, media 818), a random access memory (RAM), a read-only memory (ROM), a rigid magnetic disk and an optical disk. Current examples of optical disks include compact disk-read only memory (CD-ROM), compact disk-read and/or write (CD-R/W) and DVD.

A data processing system suitable for storing and/or executing program code will include at least one processor 802 coupled directly or indirectly to memory elements 804 through a system bus 810. The memory elements can include local memory employed during actual execution of the program code, bulk storage, and cache memories which provide temporary storage of at least some program code in order to reduce the number of times code must be retrieved from bulk storage during execution.

Input and/or output or I/O devices (including but not limited to keyboards 808, displays 806, pointing devices, and the like) can be coupled to the system either directly (such as via bus 810) or through intervening I/O controllers (omitted for clarity).

Network adapters such as network interface 814 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

At least one embodiment of the invention may provide one or more beneficial effects, such as, for example, identifying system events responsible for client incidents and configuration items (CIs) affected by an event if it is not explicitly mentioned.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for correlating a client incident with one or more enterprise events to facilitate resolution of the incident, comprising the steps of:
identifying one or more configuration items relevant to the one or more enterprise events;
identifying one or more configuration items relevant to the client incident; and
correlating the one or more enterprise events with the client incident using the one or more configuration items to facilitate resolution of the incident.

2. The method of claim 1, wherein correlating the one or more enterprise events with the client incident using the one or more configuration items comprises using a database to identify the one or more configuration items responsible for the one or more enterprise events and the incident.

3. The method of claim 2, wherein the database comprises a configuration management database (CMDB), wherein the CMDB stores one or more configuration items and their inter-relationships.

4. The method of claim 1, further comprising determining whether the client incident is a duplicate of an already existing incident.

5. The method of claim 1, further comprising determining, for each event, a relationship-graph affected by the event.

6. The method of claim 5, further comprising associating a template with each event class to limit a number of configuration items affected by the event.

7. The method of claim 6, wherein the template comprises a tree rooted at a configuration item class (CI class) with one or more nodes being one or more classes of other configuration items dependent on the event CI class and one or more edges being one or more CMDB relationships.

8. A computer program product comprising a computer readable medium having computer readable program code for correlating a client incident with one or more enterprise events to facilitate resolution of the incident, said computer program product including:
computer readable program code for identifying one or more configuration items relevant to the one or more enterprise events;
computer readable program code for identifying one or more configuration items relevant to the client incident; and
computer readable program code for correlating the one or more enterprise events with the client incident using the one or more configuration items to facilitate resolution of the incident.

9. The computer program product of claim 8, wherein the computer readable program code for correlating the one or more enterprise events with the client incident using the one or more configuration items comprises computer readable program code for using a database to identify the one or more configuration items responsible for the one or more enterprise events and the incident.

10. The computer program product of claim 9, wherein the database comprises a configuration management database (CMDB), wherein the CMDB stores one or more configuration items and their inter-relationships.

11. The computer program product of claim 8, further comprising computer readable program code for determining whether the client incident is a duplicate of an already existing incident.

12. The computer program product of claim 8, further comprising computer readable program code for determining, for each event, a relationship-graph affected by the event.

13. The computer program product of claim 12, further comprising computer readable program code for associating a template with each event class to limit a number of configuration items affected by the event.

14. The computer program product of claim 13, wherein the template comprises a tree rooted at a configuration item class (CI class) with one or more nodes being one or more classes of other configuration items dependent on the event CI class and one or more edges being one or more CMDB relationships.

15. A system for correlating a client incident with one or more enterprise events to facilitate resolution of the incident, comprising:
a memory; and
at least one processor coupled to said memory and operative to:
identify one or more configuration items relevant to the one or more enterprise events;
identify one or more configuration items relevant to the client incident; and
correlating the one or more enterprise events with the client incident using the one or more configuration items to facilitate resolution of the incident.

16. The system of claim 15, wherein in correlating the one or more enterprise events with the client incident using the one or more configuration items, the at least one processor coupled to said memory is further operative to use a database to identify the one or more configuration items responsible for the one or more enterprise events and the incident.

17. The system of claim 16, wherein the database comprises a configuration management database (CMDB), wherein the CMDB stores one or more configuration items and their inter-relationships.

18. The system of claim 15, wherein the at least one processor coupled to said memory is further operative to determine whether the client incident is a duplicate of an already existing incident.

19. The system of claim 15, wherein the at least one processor coupled to said memory is further operative to determine, for each event, a relationship-graph affected by the event.

20. The system of claim 19, wherein the at least one processor coupled to said memory is further operative to associate a template with each event class to limit a number of configuration items affected by the event.
